(19) United States
(12) Patent Application Publication
(10) Pub. No.: US 2026/0243229 A1
(43) Pub. Date: Aug. 20, 2026

(54) BLADE TIP CLAMP

(71) Applicant: Liftra IP ApS, Aalborg SV (DK)

(72) Inventors: Per Eske FENGER, Terndrup (DK); Alexander Becsei CHRISTIANSEN, Hjørring (DK)

(73) Assignee: Liftra IP ApS, Aalborg SV (DK)

(21) Appl. No.: 19/472,066

(22) PCT Filed: Apr. 3, 2024
(86) PCT No.: PCT/EP2024/059035

§ 371 Date: Oct. 2, 2025

(30) Foreign Application Priority Data
Apr. 3, 2023 (DK) PA202370167

(51) Int. Cl. F03D 13/10; F03D 80/50

(52) U.S. Cl. CPC F03D 13/104; F03D 13/139; F03D 80/502; F05B 2230/61

(57) ABSTRACT

A blade tip clamp suitable for being attached to a wind turbine blade, the blade tip clamp comprising a clamp mechanism arranged to attach the blade tip clamp to a blade near the tip of the blade, said clamp mechanism having a first configuration where the clamp mechanism is expanded and where the blade tip clamp, when arranged on a blade, is not attached to the blade and a second configuration where the clamp mechanism is retracted and where the blade tip clamp, when arranged on a blade, is attached to the blade. The blade tip clamp further comprises at least one fan unit configured to generate an air flow to apply a force to the blade when the blade tip clamp is attached to the blade. In this way, the fan unit can be used to control the position of the blade in a simple and effective manner with lower power demands and lower required sizes than prior art devices.

### DESCRIPTION OF RELATED ART

The current invention relates to a blade tip clamp suitable for being attached to a wind turbine blade near the tip of the wind turbine blade, the blade tip clamp comprising a clamp mechanism arranged to attach the blade tip clamp to a blade near the tip of the blade, said clamp mechanism having a first configuration where the clamp mechanism is expanded and where the blade tip clamp, when arranged on a blade, is not attached to the blade and a second configuration where the clamp mechanism is retracted and where the blade tip clamp, when arranged on a blade, is attached to the blade.

The current invention also relates to a method of lifting a wind turbine blade where a blade tip clamp according to the current invention is attached near the tip of the blade which is to be lifted.

When a wind turbine blade is installed, or when it needs to be removed for maintenance or replacement, the blade will be lifted from or lowered to the ground using a crane. A blade yoke is typically connected to the blade prior to the operation and then the crane lifts the blade via the blade yoke. During the crane lifting operations, the blade will be exposed to the environment, for example wind, and can therefore move in undesired directions. Likewise during motion of the crane itself, the blade, due to its inertia, can also move in undesired ways. Unwanted movement is especially undesired during the mounting of the blade to the hub, where a precise alignment needs to be ensured. In order to prevent this unwanted movement, it is typical to use tag lines to hold the blade steady and control the position more precisely. Taglines are usually connected to the blade yoke and/or to the blade itself via a blade clamp, for example a blade tip clamp, and then run to the ground where the tension in the tag lines is controlled to control the position of the blade. The tension in the tag lines can be controlled by winches and/or by human operators pulling on the taglines. In other systems, tag lines run from the blade yoke and/or the blade itself to the crane via winches.

As cranes get bigger, the required taglines are also getting bigger and longer. In addition, the forces required to maintain the blade position are also getting larger. Furthermore, in many cases, it is difficult to control tag lines from the ground. This is especially true in forest, mountainous and offshore environments.

It has previously been proposed to use fan units attached to a crane lifting yoke to control the position of a load being lifting by a crane. This is known from for example JP6605840B2, DE102012010019B4 and DE2356504A1. However the forces and power required by these proposed systems is very large. Furthermore, the fan units are very large and increase the weight of the lifting systems significantly, thereby requiring larger cranes.

### SUMMARY OF THE INVENTION

It is therefore a first aspect of the current invention to provide a device and a method to help control the position of a wind turbine blade while lifting the wind turbine blade which is easier to use than prior art devices and methods.

It is a second aspect of the current invention to provide a device and a method to help control the position of a wind turbine blade while lifting the wind turbine blade which is cheaper, lighter, less complex and consumes lower power than prior art devices and methods.

It is a third aspect of the current invention to provide a mechanism to help control the position of a wind turbine blade while lifting the wind turbine blade which can more effectively control the position of the blade than prior art devices and methods.

These aspects are provided according to a blade tip clamp as defined in the introductory paragraph and further comprising at least one fan unit configured to generate an airflow to apply a force to the wind turbine blade when the blade tip clamp is attached to the wind turbine blade. In this way, a much smaller and more compact fan unit can be provided when compared to prior art solutions.

According to the current specification, the phrase “near the tip of the wind turbine blade” should be understood as being in the outer ⅓ of the blade (when considering the longitudinal direction of the blade), in the outer ¼^{th} of the blade or in the outer ⅕^{th} of the blade. In some embodiments, the distance between the centre of gravity of the blade and the blade tip clamp is greater than 30%, greater than 40%, greater than 50% or greater than 60% of the length of the blade. In some embodiments, the distance between the centre of gravity of the blade and the blade tip clamp is at least 2 times, at least 2.5 times or at least 3 times the length of the blade yoke used to lift the blade.

According to the current specification, the term “fan unit” should be understood as a device which is arranged to generate an air flow which can be used to apply a force on the blade due to the movement of air generated by the fan unit. In many cases, the fan unit will comprise a propeller or other form of rotating element which when rotated generates airflow. The person skilled in the art will be able to provide suitable devices which can generate suitable airflows.

Furthermore, the phrase “attached to a wind turbine blade”, should be understood in that the blade tip clamp has a positive connection to the wind turbine blade, such that forces applied to the blade tip clamp are transferred to the wind turbine blade.

In some embodiments, the fan unit is arranged to generate an airflow parallel to the local chord of the blade at the location of the blade tip clamp when the blade tip clamp is attached to a blade. This is useful in situations where the blade is lifted with the blade and the chord being arranged in a horizontal position.

In some embodiments, the fan unit is arranged to generate an airflow which is perpendicular to the longitudinal axis of the blade when the blade tip clamp is attached to a blade. This will often be the case where the fan unit is arranged to cause a rotation of the blade about its COG, and about the point where it is being lifted by a crane. In some embodiments, the fan unit is arranged to generate an airflow which is both perpendicular to the longitudinal axis of the blade and parallel to the chord of the blade when the blade tip clamp is attached to the blade.

In some embodiments, the fan unit is driven by an electric motor. In some embodiments, the blade tip clamp further comprises a battery which powers the fan unit. In some embodiments, the fan unit is powered by electric power supplied by electrical cables running along the blade when the blade tip clamp is attached to a blade.

In some embodiments, the blade tip clamp comprises at least one controllable lift generating device suitable for lifting the blade tip clamp from the ground to a wind turbine blade in a controlled manner. According to this specification the term “controllable lift generating device” should be understood as a device which can generate a controllable air flow which can be used to generate lift. The generated lift can be used to lift the blade tip clamp from the ground to the blade. One common example is a rotating propeller with adjustable pitch control. By adjusting the pitch of the propeller, the lift generated by the propeller can be changed. It can also be reversed completely. This type of controllable lift generating device is well known in the art of drones.

It should be noted that according to this specification the term “ground” should be understood as a support surface located apart from the wind turbine blade. In an offshore environment, the “ground” could be a deck of a boat. In another example environment, the “ground” could be a surface of a trailer arrangement. The term ground should therefore be interpreted broadly.

In some embodiments, the blade tip clamp comprises three or more controllable lift generating devices. In some embodiments, the blade tip clamp comprises four controllable lift generating devices. In some embodiments the controllable lift generating devices are arranged in an orientation similar to a four blade drone known in the art of drones.

In some embodiments, at least one of the at least one controllable lift generating devices is arranged to function as the at least one fan unit. In this way, instead of providing one or more controllable lift generating devices and a fan unit, one or more of the one or more controllable lift generating devices can be used as the fan unit once the blade tip clamp is attached to the blade. In some embodiments, at least one controllable lift generating device is arranged such that the direction of an airflow generated by said at least one controllable lift generating device is rotatable with respect to the clamping mechanism about an axis parallel to or perpendicular to a longitudinal axis of the blade when the blade tip clamp is attached to a blade such that the at least one controllable lift generating device becomes the at least one fan unit when the at least one controllable lift generating device is rotated. In this way, the controllable lift generating device or devices can be used to lift the blade tip clamp to the blade and can then be rotated after attaching the blade tip clamp to the blade to provide an airflow needed to control the position of the blade while lifting the blade via a crane and blade yoke attached near the centre of gravity of the blade.

In some embodiments where there are multiple controllable lift generating devices, more than one and/or all of the multiple controllable lift generating devices are rotatable to become fan units. In some embodiments where there are multiple controllable lift generating devices, different controllable lift generating devices could be rotated about different axes, to provide airflow in different directions in order to more precisely control the position of the blade. In some embodiments, one controllable lift generating device could generate an airflow which is perpendicular to the longitudinal axis of the blade and the local chord of the blade while another controllable lift generating device could generate an airflow which is parallel to the local chord of the blade.

It should be noted, that in some embodiments, the controllable lift generating devices will be able to rotate both about an axis which is perpendicular to the longitudinal axis of the blade and about an axis which is parallel to the longitudinal axis of the blade. This could be implemented via two separate rotation mechanisms, for example a first mechanism which allows rotation about a first axis which is parallel to the longitudinal axis of the blade and a second mechanism which allows rotation about a second axis which is perpendicular to the longitudinal axis of the blade. It should also be noted that in certain embodiments, the blade itself is rotated about its longitudinal axis before attaching the tip clamp and then the blade is rotated about its longitudinal axis again after the blade tip clamp is attached to the blade. In this way, the direction of the airflow generated by the controllable lift generating devices can be redirected, without having to rotate the actual lift generating device relative to the clamping mechanism.

In some embodiments, at least one controllable lift generating device is rotatable through an angle of at least 75 degrees, at least 85 degrees or at least 90 degrees about an axis which is parallel to or perpendicular to the longitudinal axis of the blade when the blade tip clamp is attached to the blade. In this way, the blade tip clamp can be flown to the blade, attached to the blade and then the controllable lift generating device or devices can be rotated to provide the desired air flow direction during the lifting operation of the blade. A similar procedure can be provided at the end of the lifting operation. The controllable lift generating device or devices can be rotated such that they provide an airflow in a vertical direction, the blade tip clamp can be detached from the blade and then the blade tip clamp can be flown to the ground.

In some embodiments where there are three or four controllable lift generating devices, the minimum distance between at least two of the three or four controllable lift generating devices is greater than the local chord length of the wind turbine blade at the location where the blade tip clamp is to be attached to the blade or greater than the local blade height at the location where the blade tip clamp is to be attached to the blade. In this way, the blade tip clamp can be flown to the blade and engaged with the blade while the blade is in a vertically downward orientated position (the 6 o-clock position). According to the current specification, the local blade height is defined as the maximum distance from the top/suction surface of the blade to the bottom/pressure surface of the blade in a direction which is perpendicular to the local chord of the blade.

The current specification also discloses a method of lifting a wind turbine blade, said method comprising the steps of attaching a blade yoke to the wind turbine blade, and attaching a blade tip clamp according to any embodiment as described above near the tip of the wind turbine blade.

In some embodiments of the method, the method further comprises the steps of prior to attaching the blade tip clamp to the blade, rotating the blade such that the local chord of the blade at the location where the blade tip clamp is to be attached is arranged vertically and the longitudinal axis of the blade is arranged horizontally, and after attaching the blade tip clamp to the blade, rotating the blade and the attached blade tip clamp 90 degrees such that the local chord is horizontal. In this way, the blade tip clamp can be attached to the blade in one orientation and then the blade can be rotated to redirect the airflow of the controllable lift generating devices to be in the direction which is needed while lifting the blade via a crane and blade yoke attached to the blade near the centre of gravity of the blade.

In some embodiments of the method, the blade yoke can rotate the blade from a horizontal position to a vertical position, or from a vertical position to a horizontal position, and the blade tip clamp can be arranged to displace the tip of the blade relative to the blade yoke when the blade is in its vertical position via the airflow of the fan unit.

The current specification also discloses a second independent invention. In many cases, it is desired to attach a tag line or other accessory to a blade tip via a blade tip clamp. These blade tip clamps are typically attached while the blade is on the ground, or a crane lifts the blade tip clamp up to a blade where it is manually attached to the blade tip.

However, removing the prior art type blade tip clamps once the blade is installed on the turbine, is complicated and time consuming. In addition, in cases where a blade tip clamp needs to be installed on a blade which is already mounted on a wind turbine, it is expensive to arrange a crane which is high enough to attach a prior art type blade tip clamp to the blade.

It is therefore a first aspect of the second invention to provide a blade tip clamp which is easier to attach to a blade which is already installed on a turbine.

A second aspect of the second invention is to provide a blade tip clamp which is easier to remove from the blade when the blade is installed on the turbine. These aspects are provided according to the second invention by a blade tip clamp as described below via the following examples of the second invention.

1. A blade tip clamp for attaching to a wind turbine blade, the blade tip clamp comprising
a) a clamp mechanism arranged to attach the blade tip clamp to a blade near the tip of the wind turbine blade, said clamp mechanism having a first configuration where the clamp mechanism is expanded and where the blade tip clamp, when arranged on a wind turbine blade, is not attached to the wind turbine blade and a second configuration where the clamp mechanism is retracted and where the blade tip clamp, when arranged on a wind turbine blade, is attached to the wind turbine blade;
characterized in that said blade tip clamp further comprises
b) at least one controllable lift generating device suitable for lifting the blade tip clamp from the ground to a blade in a controlled manner.

2. A blade tip clamp according to example 1, characterized in that the blade tip clamp further comprises an attachment mechanism for attaching one or more tag lines and/or one or more other accessories to the blade tip clamp.

3. A blade tip clamp according to example 1 or 2 and any feature of any one of claims 1 to 8 or any features of any combination of one or more of claims 1 to 8.

4. Method of attaching a blade tip clamp to a wind turbine blade, said method comprising the steps of:
a) providing a blade tip clamp having at least one controllable lift generating device,
b) flying the blade tip clamp to a position near the tip of the wind turbine blade via the at least one controllable lift generating device, and
c) attaching the blade tip clamp to the wind turbine blade.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows a schematic top view of a wind turbine blade being lifted by a blade yoke with a blade tip clamp according to this disclosure mounted near the tip of the blade.

FIG. 2 shows a schematic front view of the blade of FIG. 1 with the blade yoke and the blade tip clamp according to this disclosure mounted near the tip of the blade.

FIG. 3 shows a more detailed but still schematic blade tip clamp according to this disclosure attached to a wind turbine blade, when seen along the longitudinal axis of the wind turbine blade.

FIG. 4 schematically shows another embodiment of a blade tip clamp according to this disclosure attached to a wind turbine blade.

FIG. 5 schematically shows another embodiment of a blade tip clamp according to this disclosure in a first configuration before being attached to a wind turbine blade.

FIG. 6 shows the blade tip clamp of FIG. 5 in a second configuration and attached to a wind turbine blade.

FIG. 7 schematically shows another embodiment of a blade tip clamp according to this disclosure attached to a blade arranged in a vertical orientation, for example when connected to a rotor hub (not shown).

FIG. 8 shows a schematic top view of the blade tip clamp of FIG. 7.

FIG. 9 shows another embodiment of a blade tip clamp according to this specification.

FIGS. 10 and 11 schematically show another embodiment of a blade tip clamp in two different positions of the blade.

FIG. 12 schematically shows an example of a blade tip clamp according to the second invention.

### DETAILED DESCRIPTION OF THE EMBODIMENTS

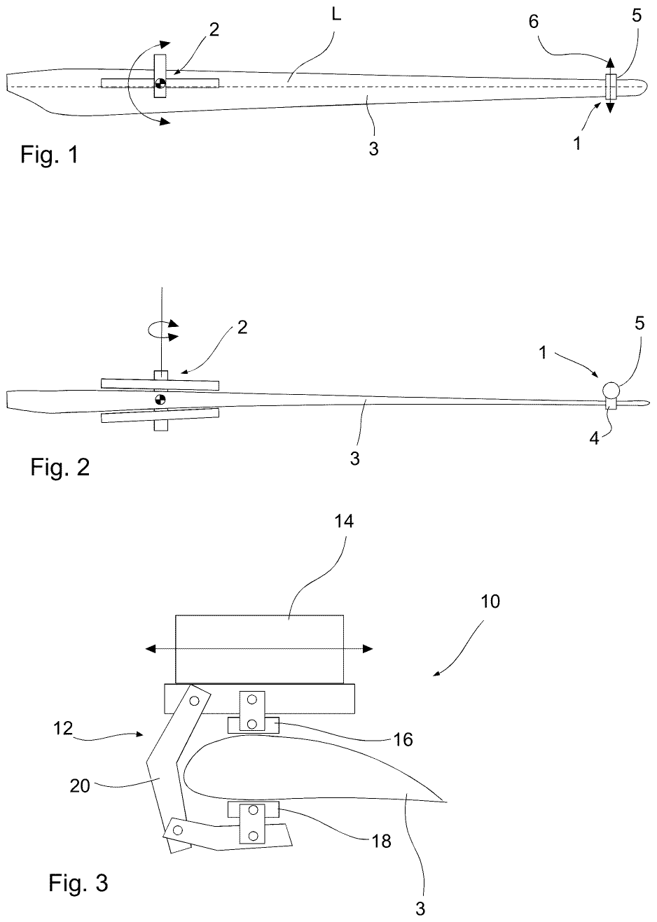

FIG. 1 shows a schematic top view of a wind turbine blade 3 being lifted by a crane (not shown) via a blade yoke 2 and having a blade tip clamp 1 according to an embodiment of this disclosure attached to the blade near the tip of the blade 3. The blade tip clamp 1, includes a clamping mechanism 4, suitable for attaching the blade tip clamp to the blade and a fan unit 5 configured to generate an airflow 6 in a direction perpendicular to the longitudinal axis L of the wind turbine blade 3 and parallel to the local chord of the wind turbine blade at the location where the blade tip clamp is attached to the blade. This airflow can be used to adjust the position of the blade 3 during a lifting procedure where the blade is lifted in a horizontal position from the ground to the top of the wind turbine for attachment to the rotor, or where the blade is detached from the rotor and lowered to the ground for maintenance or replacement.

As the fan unit generates airflow, a torque will be applied to the blade around the Center of Gravity (COG) of the blade+blade yoke combination, as well as around the lifting wire of the crane since the lifting wire of the crane will typically be attached at the COG of the blade and blade yoke combination. This will cause the blade to turn in a direction about the lifting wire of the crane. The turning direction will depend on the direction of airflow out of the fan unit. Since the blade tip clamp is placed far out on the blade, the torque generated by the fan unit can be quite large, even with the use of small fan unit.

FIG. 2 shows a schematic front view of the wind turbine blade 3 of FIG. 1 with the blade yoke 2 and the blade tip clamp 1 mounted near the tip of the blade 3.

FIG. 3 shows a more detailed but still schematic blade tip clamp 10 according to an embodiment of this disclosure. The blade tip clamp 10 comprises a clamp mechanism 12 configured to attach the blade tip clamp 10 to the blade 3. The blade tip clamp 1 further comprises a fan unit 14, for generating an airflow, which can be used to adjust the position of the blade 3 during the lifting operation. The purpose of this generated airflow is to counter unwanted movement for example due to the influence of wind or due to the motion of the crane, during a lifting procedure.

It should be noted that the figures schematically show the clamping mechanism as a mechanism which has a fixed upper pad 16 and a vertically displaceable lower pad 18 which is displaceable via a linkage mechanism 20. In this way, the clamping mechanism can “squeeze” the wind turbine blade across the central stringer of the blade where the blade is strongest. The mechanism is shown very schematically, however, blade tip clamps having clamping mechanism similar to the one shown in the figures are well known in the art and will therefore not be described in more detail here. Other types of clamping mechanisms are also possible. Later on in this specification, a clamping mechanism in the form of two pivotable arms which are rotated from a disengaged position to an engaged position is disclosed. This type of mechanism is typically less desired as it can risk damaging the leading and/or trailing edge of the blade. However, with suitable padding and an appropriate design, this could work. In another embodiment, the clamping mechanism could be a belt which wraps around the blade. When the belt is loosened, the belt is disengaged and the blade tip clamp is not firmly attached to the blade. When the belt is tightened, the belt engages with the blade and the blade tip clamp is firmly attached to the blade. In any case, the current invention should not be limited to the specific clamping mechanism.

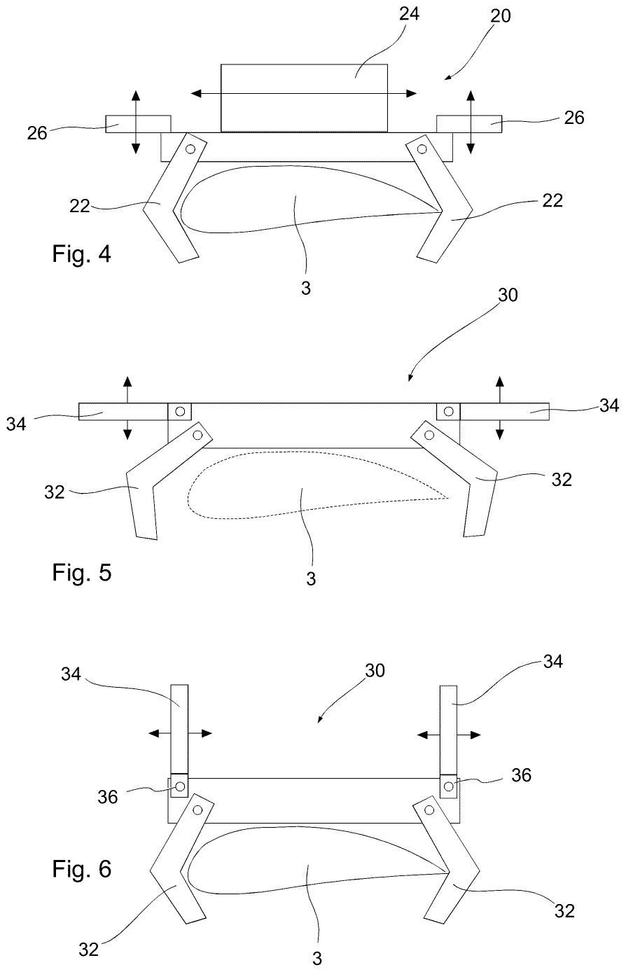

FIG. 4 schematically shows another embodiment of a blade tip clamp 20 according to this disclosure. Similar to the blade tip clamp of FIG. 3, the blade tip clamp 20 comprises a clamp mechanism 22 configured to attach the blade tip clamp 20 to the blade 3, and a fan unit 24 for generating an air flow. The blade tip clamp 20 further includes four controllable airflow generating lifting mechanisms 26, arranged in a square formation when seen from the top (not shown), similar to the well known drone configuration. In this way, the lifting mechanisms can lift the blade tip clamp from the ground up to the wind turbine blade 3 where it can be attached to the blade via the clamping mechanism. The lifting mechanisms can also lift the blade tip clamp from the blade to the ground. In other words, the blade tip clamp 20 of this embodiment, is self-lifting. The lifting mechanisms 26 may be in the form of fan units, for example adjustable pitch propeller mechanisms, that lift and manoeuver the blade tip clamp 1 in the wanted direction, by generating an air flow in a direction opposite to the desired direction of movement.

FIGS. 5 and 6 schematically show another embodiment 30 of a blade tip clamp of this disclosure. FIG. 5 shows the blade tip clamp in a first configuration where the clamping mechanism 32 is not attached to a blade and FIG. 6 shows the blade tip clamp in a second configuration where the clamping mechanism is engaged and attached to the blade.

Like the blade tip clamp of the previous embodiment shown in FIG. 4, the blade tip clamp 30 comprises a clamping mechanism 32 configured to attach the blade tip clamp 30 to the blade 3 as well as four lifting mechanisms 34 (or controllable lift generating devices) for lifting the blade tip clamp 30 from the ground to the wind turbine blade 3. In the first configuration, the lifting mechanisms 34, which may be fan units, are positioned such that the airflow generated by the lifting mechanisms is perpendicular to the ground. This means that in this configuration, the blade tip clamp 1 can be controlled by an operator, and flown from the ground to the desired position near the tip of the blade 3.

In the second configuration, the clamping mechanism has been engaged to attach the blade tip clamp firmly to the blade. The lifting mechanisms 34 have then been rotated around a first rotation axis 36 parallel to the longitudinal axis of the blade, such that the generated airflow in this second configuration is perpendicular to the longitudinal axis of the turbine blade and essentially parallel to the local chord of the blade at the location of the blade tip clamp. The lifting mechanisms 34 can then function in a manner similar to the fan units 14, 24 of FIGS. 3 and 4. This has the added advantage that the blade tip clamp 30 will be less complex and can be built more compactly and more cheaply, since the blade tip clamp has less components than the blade tip clamp described with respect to FIG. 4. In the figures shown, all four lifting mechanisms are rotated. However, in another embodiment, only one or only some of the lifting mechanisms are rotated. The remaining lifting mechanism(s) can be used to generate an airflow perpendicular to both the longitudinal axis of the blade and the local chord. In this way, the tip of the blade can be position both in an upwards/downwards direction by the unrotated lifting mechanism(s) and forward/backwards with the rotated lifting mechanism(s).

In this embodiment, the lifting mechanisms 34 are able to rotate at least 90 degrees, in order to direct the generated airflow in the desired directions. In some embodiments, the lifting mechanisms are also capable of rotating around a second rotation axis perpendicular to the first rotation axis. This will allow the generated airflow to be directed more precisely and accurately in the desired direction, to counter undesired motion of the blade 3.

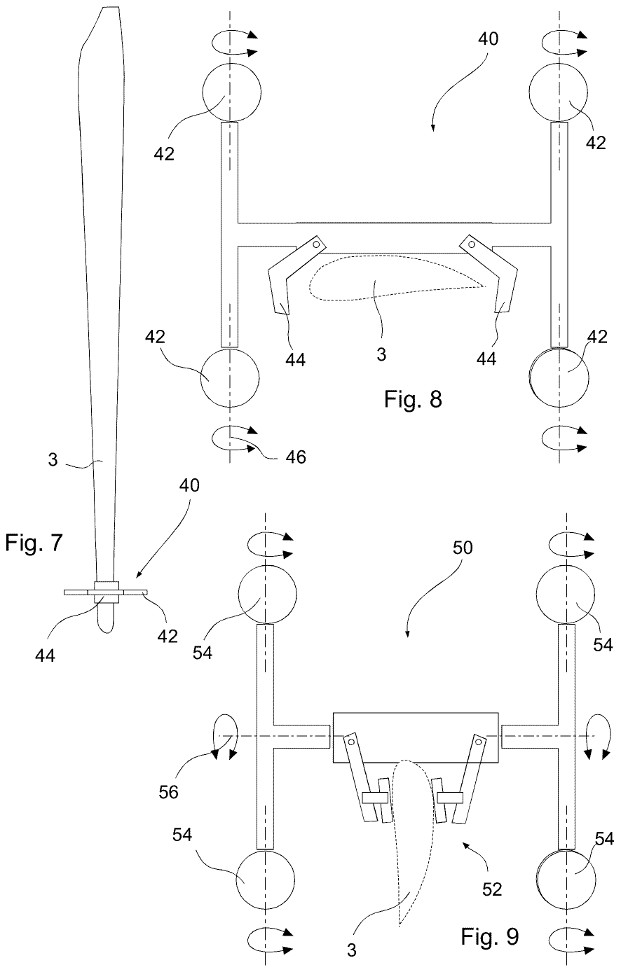

FIGS. 7 and 8 schematically show another embodiment of a blade tip clamp 40 according to this disclosure. In this case, the blade is hanging in a downward orientation (FIG. 7) from a hub (not shown). In this case, it is desired to attach the blade tip clamp while the blade is hanging in this position. This position is more demanding for the self lifting blade tip clamp, since the blade tip clamp needs to fly close to the blade. In order to avoid having to place the clamping mechanism off centre with respect to the lifting devices, the lift generating devices 42 need to be able to move past the blade 3 itself. In this embodiment, the distance between the lift generating devices 42 is greater than the local chord length of the wind turbine blade 3. As in the previous embodiments, the blade tip clamp 40 has a clamping mechanism 44 for attaching to the blade 3, and a plurality of lift generating devices 42. As in the previous embodiments, the lift generating devices are arranged to rotate about axes 46 to change the direction of the generated airflow to control the positioning of the blade during the blade lifting operation.

It should be noted that blades are sometimes lifted in a horizontal position, as shown in FIGS. 1 and 2, but are also sometimes lifted in a vertical orientation as shown in FIG. 7. When being lifted in a horizontal position, the fan unit of the blade tip clamp of this disclosure could be arranged as shown in FIGS. 1 and 2, in other words parallel to the local chord of the blade at the location of the blade tip clamp. However, when being lifted in a vertical orientation, the fan unit of the blade tip clamp of the current disclosure could be arranged in a different direction. For example, the fan unit could be arranged perpendicular to the local chord of the blade, such that the tip position of the blade can be controlled in a direction perpendicular to the chord of the blade. This could be used to prevent the tip of the blade from swinging in towards the tower.

FIG. 9 shows another embodiment 50 of a blade tip clamp according to the current disclosure. This embodiment comprises a clamping mechanism 52 similar to the one shown in FIG. 3 as well as four lift generating devices 54 similar to the embodiment of FIG. 8. However, in this embodiment, the lift generating devices are further rotatable about a second axis 56 such that the blade tip clamp can be flown to a location where the blade is arranged essentially horizontally (similar to the embodiment of FIGS. 5 and 6) and to a location where the blade is arranged essentially vertically (FIGS. 7 and 8).

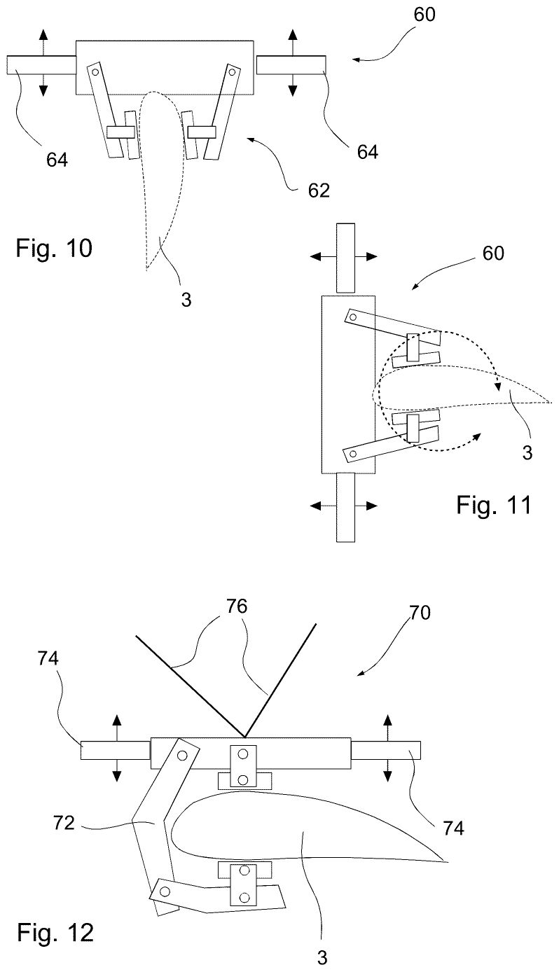

FIGS. 10 and 11 show another embodiment 60 of a blade tip clamp according to the current disclosure. This embodiment has a clamping mechanism 62 similar to the one of FIG. 3, but with four lift generating devices 64 which are fixed with respect to the clamping mechanism. In this case, the four lift generating devices are arranged such that the airflow generated by the four lift generating devices is essentially parallel to the chord of the blade where it is attached. In this case, the blade is first arranged in a position where it is essentially horizontal (its longitudinal axis is essentially horizontal) and then the blade is rotated about its own longitudinal axis until the chord of the blade is essentially vertical. The blade tip clamp 60 can then be flown up to the blade and attached by lowering the blade tip clamp onto the blade and then engaging the clamping mechanism 62 as shown in FIG. 10. The blade itself is then rotated about its own longitudinal axis. Since the blade tip clamp is fixed to the blade, the blade tip clamp will rotate with the blade. As such, the blade tip clamp will now be arranged such that the lift generating devices are generating an airflow which rotates the blade around the COG of the blade when it is being lifted by the crane. It is noted that in order to reduce the forces due to wind acting on the blade, the blade is typically lifted in a position where the chord is horizontally arranged since the wind will typically also be acting in a horizontal plane. By rotating the blade such that the chord is horizontal, the frontal area of the blade exposed to the wind will be minimized.

FIG. 12 shows a non-claimed example of another type of blade tip clamp 70. In this embodiment, the blade tip clamp 70 further includes a clamping mechanism 72 as known in the art and four lift generating devices 74 in an arrangement similar to a drone. However, the blade tip clamp 70 of this embodiment, does not have a fan unit which generates airflow parallel to the chord of the blade. However, instead, the blade tip clamp has one or more attachment mechanisms for attaching one or more tag lines 76 to the blade tip clamp. As such, this embodiment could be covered by claims based on examples 1 to 4 disclosed in this specification.

It is to be noted that the figures and the above description have shown the example embodiments in a simple and schematic manner. Many of the specific mechanical details have not been shown since the person skilled in the art should be familiar with these details and they would just unnecessarily complicate this description. For example, the specific materials used and the specific manufacturing procedures have not been described in detail since it is maintained that the person skilled in the art would be able to find suitable materials and suitable processes to manufacture the blade tip clamp according to the current invention.

1. A blade tip clamp suitable for being attached to a wind turbine blade near the tip of the wind turbine blade, the blade tip clamp comprising:
a) a clamp mechanism arranged to attach the blade tip clamp to a blade near the tip of the wind turbine blade, said clamp mechanism having a first configuration where the clamp mechanism is expanded and where the blade tip clamp, when arranged on a wind turbine blade, is not attached to the wind turbine blade and a second configuration where the clamp mechanism is retracted and where the blade tip clamp, when arranged on a wind turbine blade, is attached to the wind turbine blade;
characterized in that said blade tip clamp further comprises
b) at least one fan unit configured to generate an air flow to apply a force to the wind turbine blade when the blade tip clamp is connected to the wind turbine blade.

2. The blade tip clamp according to claim 1, characterized in that the fan unit is arranged to generate an airflow parallel to the local chord of a wind turbine blade at the location of the blade tip clamp when the blade tip clamp is attached to the wind turbine blade.

3. The blade tip clamp according to claim 1, characterized in that the fan unit is arranged to generate an airflow perpendicular to the local chord of a wind turbine blade at the location of the blade tip clamp when the blade tip clamp is attached to the wind turbine blade.

4. The blade tip clamp according to claim 1, characterized in that the fan unit is arranged to generate an airflow which is perpendicular to a longitudinal axis of a wind turbine blade when the blade tip clamp is attached to the wind turbine blade.

5. The blade tip clamp according to claim 1, characterized in that the blade tip clamp further comprises a battery which powers the fan unit.

6. The blade tip clamp according to claim 1, characterized in that the blade tip clamp comprises at least one controllable lift generating device suitable for lifting the blade tip clamp from the ground to a wind turbine blade in a controlled manner.

7. The blade tip clamp according to claim 6, characterized in that at least one of the at least one controllable lift generating devices is arranged to function as the at least one fan unit.

8. The blade tip clamp according to claim 7, characterized in that said at least one controllable lift generating device which is arranged to function as the at least one fan unit is arranged such that the direction of an airflow generated by said at least one controllable lift generating device is rotatable with respect to the clamping mechanism about an axis parallel to and/or perpendicular to a longitudinal axis of the blade when the blade tip clamp is attached to a blade.

9. The blade tip clamp according to claim 1, characterized in that when there are four controllable lift generating devices, the distance between at least two of the four controllable lift generating devices is greater than the local chord length of the wind turbine blade at the location where the blade tip clamp is to be attached to the blade or greater than the local blade height at the location where the blade tip clamp is to be attached to the blade.

10. A method of lifting a wind turbine blade, said method comprising the steps of:
a) attaching a blade yoke to the wind turbine blade, and
b) attaching a blade tip clamp according to any one of claims 1 to 9 near the tip of the wind turbine blade.

11. The method according to claim 10, characterized in that the method further comprises the steps of:
a) prior to attaching the blade tip clamp to the wind turbine blade, rotating the wind turbine blade such that the local chord of the wind turbine blade at the location where the blade tip clamp is to be attached is arranged vertically and the longitudinal axis of the blade is arranged horizontally, and
b) after attaching the blade tip clamp to the wind turbine blade, rotating the wind turbine blade and the attached blade tip clamp 90 degrees such that the local chord of the wind turbine blade at the location where the blade tip clamp is attached to the wind turbine blade is horizontal.
